(19) United States
(12) Patent Application Publication
(10) Pub. No.: US 2026/0064781 A1
(43) Pub. Date: Mar. 5, 2026

(54) LLM FRAMEWORK FOR LARGE SCALE APPLICATIONS

(71) Applicant: DoorDash, Inc., San Francisco, CA (US)

(72) Inventors: Zhe Jia, Sunnyvale, CA (US); Shuai Wang, Bellevue, WA (US); Aditi Bamba, Los Angeles, CA (US); Yu Wang, Palo Alto, CA (US)

(73) Assignee: DoorDash, Inc., San Francisco, CA (US)

(21) Appl. No.: 19/313,108

(22) Filed: Aug. 28, 2025

Related U.S. Application Data
(60) Provisional application No. 63/688,636, filed on Aug. 29, 2024.

(51) Int. Cl. G06F 16/93; G06F 16/215; G06F 16/2457

(52) U.S. Cl. CPC G06F 16/93; G06F 16/215; G06F 16/24578

(57) ABSTRACT

A method includes a computer receiving a user query. The computer generates a summary of the user query using a first large language model. The computer determines a user issue from a first database based on the summary. The computer determines digital document from a second database based on the user issue. The computer generates a prompt based on the digital document and a prompt template. The computer generates a response based on the prompt using a second large language model.

### CROSS-REFERENCES TO RELATED APPLICATIONS

This application claims the benefit of U.S. Provisional Application No. 63/688,636, filed Aug. 29, 2024, which is herein incorporated by reference in its entirety for all purposes.

### SUMMARY

One embodiment is related to a method comprising: receiving, by a computer, a user query; generating, by the computer, a summary of the user query using a first large language model; determining, by the computer, a user issue from a first database based on the summary; determining, by the computer, a digital document from a second database based on the user issue; generating, by the computer, a prompt based on the digital document and a prompt template; and generating, by the computer, a response based on the prompt using a second large language model.

Another embodiment is related to a computer comprising: a processor; and a non-transitory computer readable medium comprising code, executable by the processor for performing operations comprising: receiving a user query; generating a summary of the user query using a first large language model; determining a user issue from a first database based on the summary; determining a digital document from a second database based on the user issue; generating a prompt based on the digital document and a prompt template; and generating a response based on the prompt using a second large language model.

Another embodiment is related to a method comprising: displaying, by a user device, a text chat between a user and a chatbot hosted by a computer; receiving as input, by the user device, one or more text messages from the user for the text chat; providing, by the user device, the one or more text messages to the computer, wherein the one or more text messages and other messages from the text chat are included in a user query, wherein the computer generates a summary of the user query using a first large language model, determines a user issue from a first database based on the summary, determines a digital document from a second database based on the user issue, generates a prompt based on the digital document and a prompt template, and generates a response based on the prompt using a second large language model; and receiving, by the user device, the response from the computer.

Further details regarding embodiments of the disclosure can be found in the Detailed Description and the Figures.

### BRIEF DESCRIPTION OF THE DRAWINGS

FIG. 1 shows a block diagram of a system according to embodiments.

FIG. 2 shows a block diagram of components of a processing computer according to embodiments.

FIG. 3 shows a diagram illustrating a RAG based support system according to embodiments.

FIG. 4 shows a hybrid flow diagram illustrating response generation according to embodiments.

FIG. 5 shows a hybrid diagram illustrating a response output guardrail system and method according to embodiments.

FIG. 6 shows a hybrid diagram illustrating a large language model judge system and quality improvement framework according to embodiments.

FIG. 7 shows a block diagram of a system according to embodiments.

### DETAILED DESCRIPTION

Prior to discussing embodiments of the disclosure, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor and a computer-readable medium coupled to the processor, the computer-readable medium comprising code, executable by the processor. The user device may also each include an external communication interface for communicating with each other and other entities. Examples of user devices may include a mobile device (e.g., a mobile phone), a laptop or desktop computer, a wearable device (e.g., smartwatch), etc.

A “fulfillment request” or “fulfillment request message” can be a request to provide a resource in response to a request. For example, a fulfillment request can include an initial communication from an end user device to a central server computer for a first service provider computer to fulfill a purchase request for a resource such as food. A fulfillment request can be in an initial state, a partially completed state, or a final state. After the fulfillment request is in a final state, it can be accepted by the central server computer, and the central server computer can send a fulfillment request confirmation to the end user device. An exemplary fulfillment request can include a list of items to be purchased in an order, the quantity of each item to be purchased, an end user identifier for the user that initiates the fulfillment request, a total amount of the fulfillment request, and a timestamp associated with the fulfillment request.

A “transporter” can be an entity that transports something. A transporter can be a person that transports a resource using a transportation device (e.g., a car). In other embodiments, a transporter can be a transportation device that may or may not be operated by a human. Examples of transportation devices include cars, boats, scooters, bicycles, drones, airplanes, etc. A transporter may also use a user device (e.g., a driver using a mobile phone) or a user device be in coupled to the transporter (e.g., a telecommunications unit in an autonomous vehicle).

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “language model” can include a probabilistic model relating to evaluating natural language. A language model can include a large language model (LLM). A large language model can include a transformer and can be utilized to evaluate data.

A “user query” can include a request for information. A user query can include a request for information relating to an issue. A user query can include a text question. A user query can include a chat history between a user of a user device and a chatbot. A user query can indicate that a user of a user device has an issue, a question, or other query.

A “summary” can include a brief statement or account of the main points of something. A summary can summarize a source text. A summary can include text that describes the source text. A summary can be generated by a machine learning model, such as a large language model, based on an input source text. For example, a computer can utilize a large language model to generate a summary based on a user query.

An “issue” can include problems or difficulties. An issue can include a problematic situation that can be overcome.

A “user issue” can include a problem that a user is experiencing. As an illustrative example, in a fulfilment system, a user issue can include a problem such as “waiting too long for items,” “an item is damaged,” “a delivery location cannot be found,” “a transporter has not arrived,” “a transporter has not picked up items from a service provider,” etc.

A “digital document” can include electronic matter that provides information or evidence. A digital document can include an article or a digital file.

An “article” can include piece of writing. An article can include text about a particular topic. An article can describe how to solve an issue.

A “prompt” can include text that is provided to invoke a response. A prompt can include an instruction. A prompt can include input text that is provided to a large language model to obtain a response.

A “chatbot” can include a computer program that is designed to simulate conversation with a human user. A chatbot can utilize natural language processing (NLP) and/or large language models. A chatbot can receive text from a user device operated by a user, generate text responses, and provide the text responses to the user device.

A “link” can include digital reference providing direct access to data. A link can be a hyperlink. A link can point to a whole digital document or to a specific element within a digital document. A link can include hypertext, which can include text with hyperlinks. The text that is linked from is known as anchor text.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

When users encounter difficulties, they can reach out to a support computer. The support computer can provide automated solutions for the user's issue and can connect the users to human support agents as needed. The automated support system typically resolves the user's issue faster than the human agents because the system does not require the user to wait before being connected to the agent, and the system itself provides answers faster than a human representative.

Flow based chatbot systems (e.g., state machines) can be used to guide users through predefined workflows. The state machines can use a classification ML model to identify user intents from user submitted sentences (e.g., spoken words) and move the process to consequent nodes in the workflow based on the user's intents.

However, this approach has a number of technical problems: 1) the approach can only identify the user's intent based on a single sentence; 2) the approach can only resolve issues based on predefined path; and 3) the approach can only offer predefined resolutions. As such, existing automated support systems are flow based resolution systems, which rely heavily on pre-built resolution paths, and can only resolve a small subset of the user's issues.

There can also be a collection of knowledge base articles for the users to read when they have issues. However, there are technical challenges that hinder these articles from being helpful to the users: 1) it can be difficult to find the correct article, 2) it takes time to find the useful information from the article, and 3) the articles are in English, but many users prefer another language.

Furthermore, such aforementioned technical challenges, cannot simply be solved by using a large language model (LLM) to provide answers to the user. With the recent developments in chatbot technology, large language models (e.g., GPT-4, Claude-3, etc.) are known for their ability to produce responses that mimic human-like quality and fluency. However, they are not without their errors. Unaddressed, these errors can lead to significant issues. For example, large language models can generate false information, which could further compound a user's difficulties.

Embodiments of the disclosure address this problem and other problems individually and collectively.

Embodiments of the disclosure provide for automated user (e.g., end users, transporters, resource provider agents, etc.) support with a large language model while maintaining a truth base for fact verification using a digital document database (e.g., which can include prewritten digital documents).

The system can dynamically identify user needs based on a received user query that can include a question and/or an entire conversation between the user and another large language model (e.g., a chatbot). For example, the system can determine a user issue that the user is experiencing. The system can identify and obtain relevant digital documents from databases that can be helpful to resolve the issue for the users. After obtaining the relevant digital documents, the system can generate a response using a large language model, the identified user issue from the user's query, and the digital document(s).

Embodiments can ensure high quality response and action from the large language model using one or more guardrails. The guardrail system can review the response or action before providing the response back to the user.

Embodiments, can further evaluate and iterate to improve the quality of the system with a large language model judge. The judge system can perform retroactive evaluation and iteratively improve the whole of the system.

Embodiments solve a technical problem where it is challenging to access and maintain a high quality of large language model responses due to the randomness inherent to large language models (e.g., unpredictable outputs that can include false information). Further, when the quality of the responses is already high, then it can take a lot of effort to uncover a potential flaw since it can be hidden, and it takes even more effort to test if the flaw is fixed.

Several additional technical challenges exist with large language models including 1) groundedness and relevance of responses, 2) context summarization accuracy, 3) language consistency in responses, and 4) latency.

For the technical challenge of groundedness and relevance of responses in a retrieval augmented generation (RAG) system, it is observed that instances exist where the generated responses diverged from the intended context. Despite the responses sounding natural and legitimate, users may not realize the inaccuracies. This discrepancy often stems from the inclusion of outdated or incorrect information during the large language model's training phase. Given that large language models typically draw from publicly available text, including discussions on social media platforms, the risk of propagating erroneous information is heightened. Consequently, there is a technical challenge of users that seek assistance may not receive the intended support and rather may receive false information.

For the technical challenge of context summarization accuracy, to retrieve the most relevant information, a computer can first clearly summarize the user's issue from a previous multi-turn conversation between the user and a chatbot system. The actual issue that the user is having may change as the conversation progresses, and the presentation of the summary affects the result of the retrieval system. The accuracy and correctness of the summarization system can have a high quality impact for the remaining parts of the RAG system to provide a correct resolution for the user's issue.

For the technical challenge of language consistency in responses, ensuring language consistency is desirable, especially when users interact with a chatbot in languages other than English. As large language models primarily train on English data, they may occasionally overlook instructions to respond in other languages, particularly when the prompt itself is in English.

For the technical challenge of latency, depending on different models and size of the prompts, latency can vary from under a second to tens of seconds. Generally a larger prompt and/or a more intelligent model can lead to slower response.

To resolve the technical challenges, embodiments provide a technical solution as described in further detail herein that can include three systems: a large language model guardrail, a large language model judge, and a quality improvement pipeline to serve a RAG system.

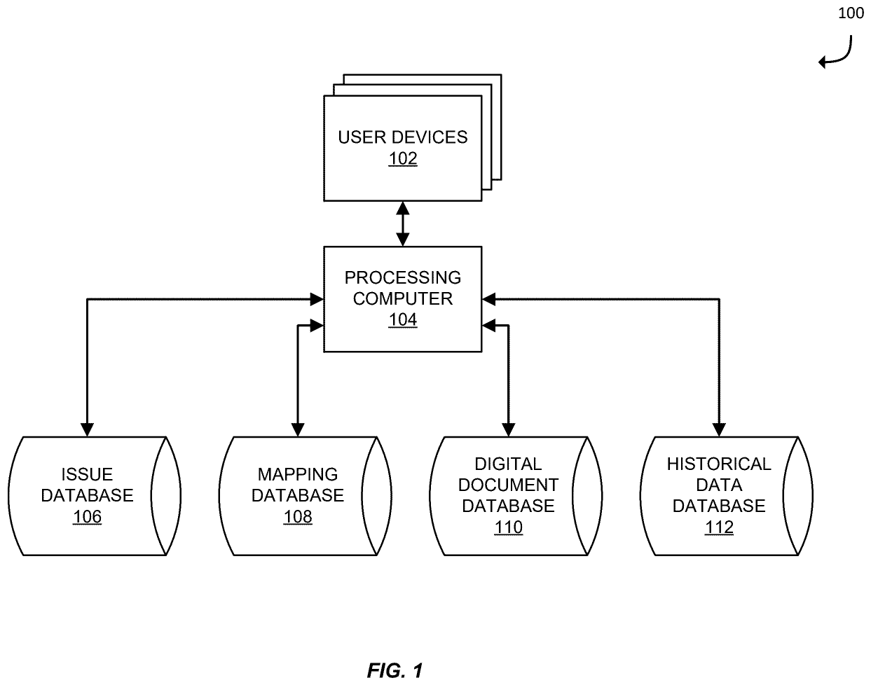

FIG. 1 shows a system 100 according to embodiments of the disclosure. The system 100 comprises user devices 102, a processing computer 104, and a plurality of databases. The plurality of databases include an issue database 106, a mapping database 108, a digital document database 110, and a historical data database 112.

The processing computer 104 can be in operative communication with the user devices 102, the issue database 106, the mapping database 108, the digital document database 110, and the historical data database 112.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between at least the devices in the system 100 illustrated in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user devices 102 can include devices operated by users (e.g., end users, transporters, etc.). The user devices 102 can include smartphones, laptop computers, desktop computers, tablets, smartwatches, etc. The user devices 102 can generate user queries that can be sent to the processing computer 104. In some embodiments, a user query can include a text question. In other embodiments, the user query can include a chat history between the user of the user device and a chatbot, such as a chatbot on a website. The user query can indicate that the user of the user device has an issue, a question, or other query.

The processing computer 104 can be a computer or server that can process data. The processing computer 104 can process user queries and can generate responses. The processing computer 104 can receive a user query from a user device of the user devices 102. The processing computer 104 can process the user query to generate a response that can respond to the user's issue, question, or other query.

For example, after receiving the user query, the processing computer 104 can generate a summary of the user query using a first large language model. The processing computer 104 can then determine a user issue from the issue database 106 based on the summary.

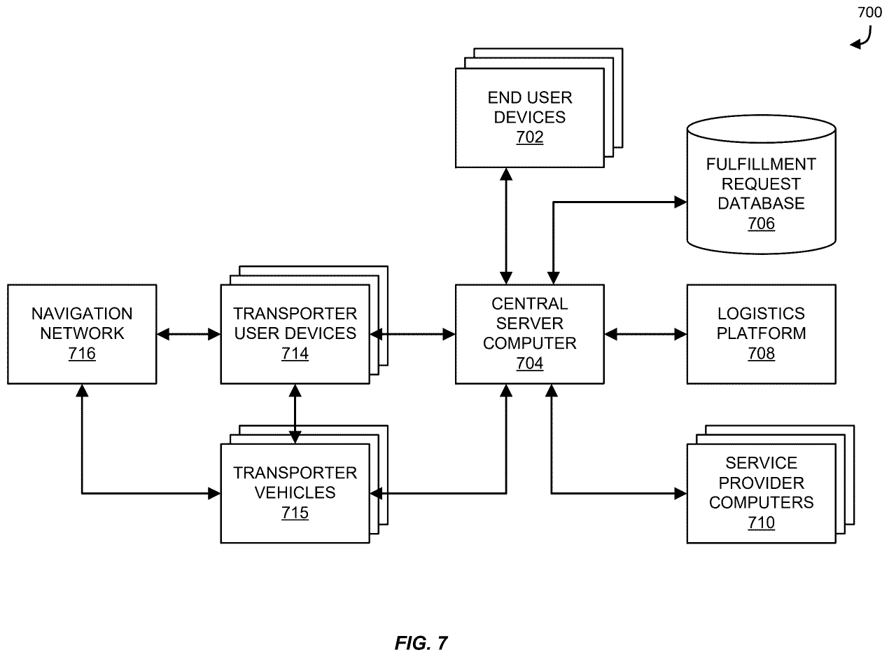

The issue database 106 can store issues that the summary can be associated with. The issue database 106, in some embodiments, can be a question database or other query database. The issue can be, for example, that the user of the user device (who can be a transporter, as described in reference to FIG. 7) has waited too long at a service provider location to pickup resources for transport.

After determining the user issue, the processing computer 104 can determine a digital document identifier from the mapping database 108 based on the user issue. The mapping database 108 can store identified linkages between digital documents and issues. Issues can be mapped to digital documents. The mapping database 108 can store a mapping between digital documents and issues. The processing computer 104 can request a digital document identifier from the mapping database 108 using the user issue. In response, the mapping database 108 can provide the digital document identifier to the processing computer 104.

The digital document database 110 can store information. The digital document database 110 can be a digital document database and can store digital documents. The processing computer 104 can determine a digital document from a digital document database 110 using the digital document identifier. The processing computer 104 can obtain the digital document from the digital document database 110.

After obtaining the digital document, The processing computer 104 can then generate a prompt based on the digital document and a prompt template. The processing computer 104 can generate a response a response based on the prompt using a second large language model. The processing computer 104 can also perform other processing step related to the response as described in detail herein. The processing computer 104 can store the response in the historical data database 112 as well as provide the response to the user device of the user devices 102.

The historical data database 112 can include historical cases that the processing computer 104 has processed. For example, the historical data database 112 can store generated responses. The historical data database 112 can store other information related to a generated response. The historical data database 112 can store any data utilized to process a user request and determine a response. For example, the historical data database 112 can store user queries, digital document identifiers, responses, modified responses, etc.

The issue database 106, the mapping database 108, the digital document database 110, and the historical data database 112 can include any suitable databases. The database may be a conventional, fault tolerant, relational, scalable, secure database such as those commercially available from Oracle™ or Sybase™.

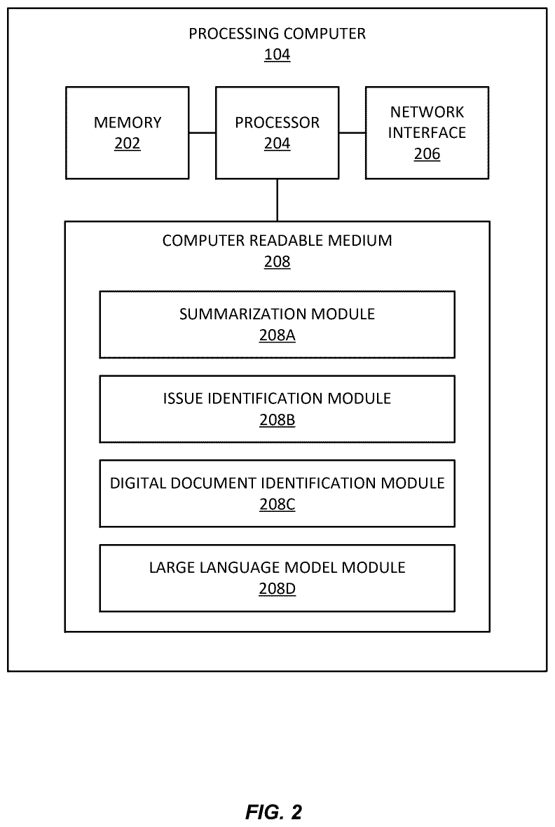

FIG. 2 shows a block diagram of a processing computer 104 according to embodiments. The exemplary processing computer 104 may comprise a processor 204. The processor 204 may be coupled to a memory 202, a network interface 206, and a computer readable medium 208. The computer readable medium 208 can comprise one or more modules. The computer readable medium 208 can comprise a summarization module 208A, a issue identification module 208B, a digital document identification module 208C, and a large language model module 208D.

The memory 202 can be used to store data and code. For example, the memory 202 can store fulfilment data, historical data, chat data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a computer, a user query; generating, by the computer, a summary of the user query using a first large language model; determining, by the computer, a user issue from a first database based on the summary; determining, by the computer, a digital document from a second database based on the user issue; generating, by the computer, a prompt based on the digital document and a prompt template; and generating, by the computer, a response based on the prompt using a second large language model. The first database can be an issue database. The second database can be a digital document database (e.g., an digital document database).

The summarization module 208A may comprise code or software, executable by the processor 204, for summarizing text. The summarization module 208A, in conjunction with the processor 204, can generate a summary for an input. The summarization module 208A, in conjunction with the processor 204, can include a large language model. The large language model can be prompted to generate a summary for input text. The summarization module 208A, in conjunction with the processor 204, can obtain a user query and can generate a summary of the user query. For example, the user query can include a text conversation between a user and a chatbot. The summarization module 208A, in conjunction with the processor 204, can generate a summary of the text conversation. The text conversation can include a conversation about an issue that the user is experiencing. The summary can include a description of the issue.

The issue identification module 208B may comprise code or software, executable by the processor 204, for identifying issues. The issue identification module 208B, in conjunction with the processor 204, can determine an issue in an issue database that matches a current user issue that is identified in the summary. The issue identification module 208B, in conjunction with the processor 204, can search the issue database for a top N matches that most closely match the issue described in the summary. The issue identification module 208B, in conjunction with the processor 204, can evaluate the top N matches obtained from the issue database 410. In some embodiments, the issue identification module 208B, in conjunction with the processor 204, can select a most relevant issue or issues from the top N matches. The selected issue or issues can be used to identify the issue or issues that the user is experiencing.

The digital document identification module 208C may comprise code or software, executable by the processor 204, for identifying digital documents. The digital document identification module 208C, in conjunction with the processor 204, can obtain an issue from the issue identification module 208B. The digital document identification module 208C, in conjunction with the processor 204, can identify an issue to digital document mapping from a mapping database using the obtained issue. The digital document identification module 208C, in conjunction with the processor 204, can identify and obtain a digital document identifier from the mapping database, where the digital document identifier identifies a particular digital document that is associated with the issue. The digital document identification module 208C, in conjunction with the processor 204, can obtain a digital document from a digital document database using the digital document identifier.

The large language model module 208D may comprise code or software, executable by the processor 204, for maintaining and utilizing a large language model. The large language model module 208D, in conjunction with the processor 204, can process input data, which can include text, to determine output data. The large language model module 208D, in conjunction with the processor 204, can generate a response to the user query using the digital document as obtained by the digital document identification module 208C. In some embodiments, the large language model module 208D, in conjunction with the processor 204, can obtain a prompt template and can generate the response using the prompt template and the digital document.

The network interface 206 may include an interface that can allow the processing computer 104 to communicate with external computers. The network interface 206 may enable the processing computer 104 to communicate data to and from another device (e.g., one or more user devices, one or more transporter user devices, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

### I. User Support Processing Overview

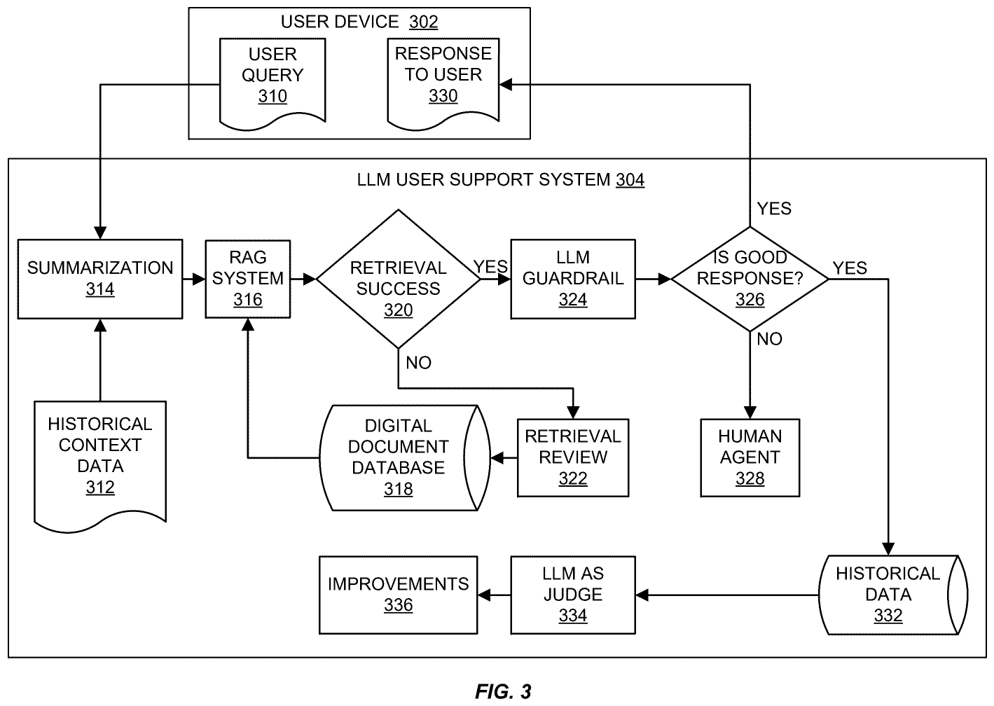

FIG. 3 shows a diagram illustrating a retrieval augmented generation (RAG) based support system according to embodiments. FIG. 3 includes different sections of the system including a user device 302 and a large language model user support system 304.

The user device 302 can be a user device of the user devices 102 as illustrated in FIG. 1. The large language model user support system 304 can be a system that processes user queries and generates responses. A processing computer can include one or more elements of the large language model user support system 304. The following description will be described in reference to the processing computer performing each step. However, it is understood that other computers can be present and can perform processing of one or more of the steps. For example, a large language model as a judge process can be performed by a second processing computer.

At step 310, the user device 302, operated by a user, can generate a user query. The user query can include a text question and/or a chat history between the user and a chatbot. For example, the user can be a transporter that is waiting for resources from a service provider location. The transporter can be waiting for a length of time that they determine as being too long. The transporter can communicate with a chatbot in a fulfilment application and can describe waiting too long at the service provider location in a text chat with the chatbot (or other text input system). The user query can include the text history about waiting too long between the user and the chatbot.

For example, the user device 302 can display a text chat between a user and a chatbot hosted by a computer. The chatbot can be hosted by any suitable computer, such as the processing computer. The user device 302 can receive input of one or more text messages from the user for the text chat. The text messages can include text input by the user of the user device 302. For example, a text message can include “I am waiting for a long time to pick up the items.” The user device 302 can provide the one or more text messages to the processing computer. The one or more text messages and other text messages from the text chat can be included in the user query.

As an illustrative example, the user query can include the following chat history: “[user]: I am at the location to pick up the food. [user]: it is taking a long time. [user]: what should I do? [chatbot]: I'm sorry to hear that. How long have you been waiting for the food? [user]: 20 minutes. [chatbot]: Let's get you information about what to do.”

The user device 302 can send the user query to the processing computer for processing. In some embodiments, the user device 302 can also provide additional data such as user data (e.g., account number, user identifier, etc.) and/or user device data (e.g., device identifier, application identifier, etc.) to the processing computer.

In some embodiments, at step 312, after receiving the user query, the processing computer can obtain historical context data related to the user query 310. The historical context data can include data related to the current user query, the user, the user device, and/or the user's current task (e.g., transport resources to an end user, obtain resources from a service provider, select resources via a fulfilment application, etc.). The historical context data can include previous user queries and responses, previous user fulfilment data, etc.

For example, the processing computer can obtain, from a database, historical context data that is associated with previous user queries provided by the user device 302.

At step 314, after obtaining the user query, the processing computer can generate a summary of the user query using a first large language model. The aforementioned chatbot can be a second large language model that is different from the first large language model. The processing computer can generate a summary that can include a summarized description of the user query. For example, the processing computer can generate a summary for the chat history such as “a user is waiting too long at a service provider.”

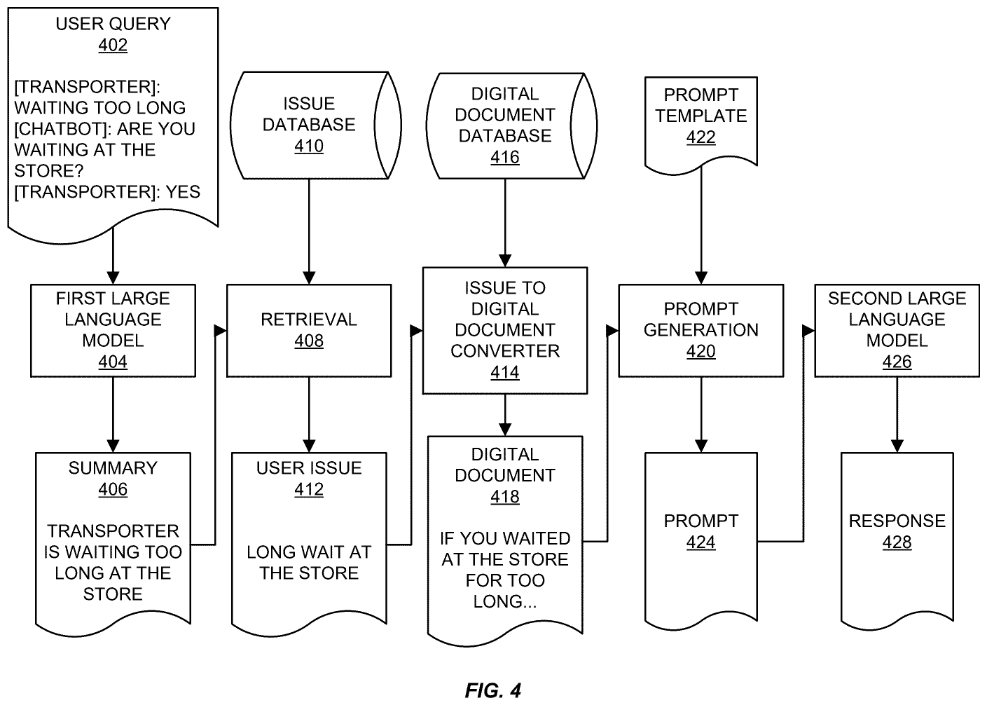

At steps 316-318, after generating the summary, the processing computer can perform a retrieval augmented generation process that includes obtaining data from a digital document database. The retrieval augmented generation process is further described in reference to FIG. 4, below. For example, the processing computer can obtain a digital document (e.g., an article) based on an issue identified in the summary and can generate a response to the user based on the digital document.

At step 320, the processing computer can determine whether or not the retrieval from the knowledge base was successful. If the retrieval was successful, the processing computer can proceed to step 324. If the retrieval was not successful, the processing computer can proceed to step 322. For example, the retrieval process may be unsuccessful if no digital documents exist that are related close enough to a user's issue (e.g., as determined using a threshold comparison process).

At step 322, the processing computer can generate a retrieval review notification for the retrieval process to be reviewed as there was a problem obtaining information from the digital document database. For example, one such problem can include no digital documents existing in the digital document database that relate to an issue of “transporter lost the items for the delivery.”

The processing computer can be prompted to reperform step 316 with a different comparison threshold such that more digital documents can be identified, with a specific digital document to use, with information that indicates that no digital document yet exists for the issue, or other information that can aid the processing computer in generating a response.

In some embodiments, the processing computer can notify an expert to review the current user query and its processing in the retrieval augmented generation process. The expert can add additional information into the knowledge base (e.g., create a new digital document) for the retrieval augmented generation process to obtain.

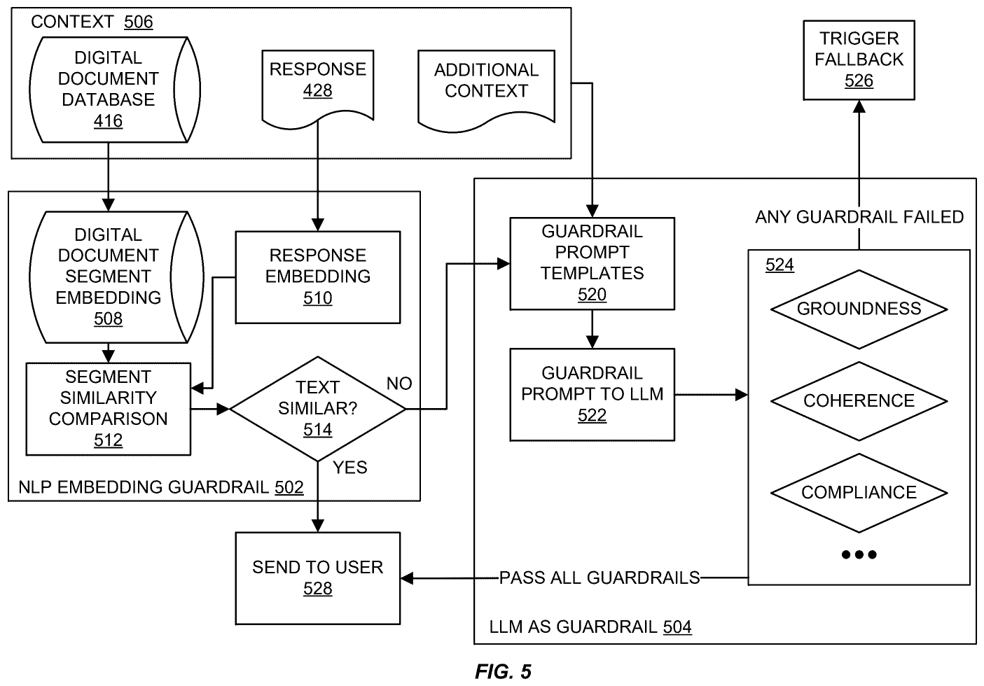

At step 324, after generating the response, the processing computer can perform a large language model guardrail process that can evaluate the response generated by the retrieval augmented generation process. The large language model guardrail process is further described in reference to FIG. 5. The large language model guardrail process can output an indication of whether or not the response is good (e.g., is acceptable to be provided to the user). The response can be determined as being good based on a threshold value of quality determined by the large language model guardrail process.

At step 326, the processing computer can evaluate whether or not the response is good. If the response is not good, then the processing computer can proceed to step 328. If the response is good, then the processing computer can proceed to step 330.

At step 328, the processing computer can notify a human agent to review the user query and response. The human agent can potentially modify the response. The processing computer can utilize the modified response and can proceed to step 330.

At step 330, after generating the response and evaluating the response for quality, the processing computer can provide the response to the user device 302 in response to receiving the user query. The response can be provided to the user device via the chatbot, a webpage, and/or a notification in a fulfilment application.

At step 332, the processing computer can store the response, the user query, and/or any other data associated with processing the user query and generating the response into a historical data database.

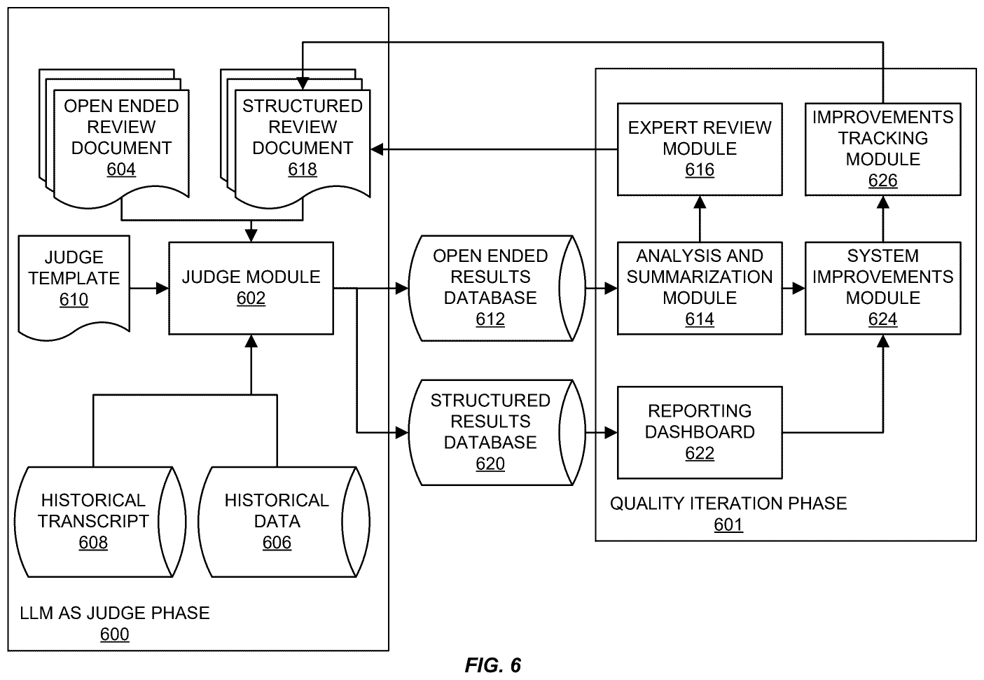

At step 334, the processing computer can perform a large language model as judge process. The large language model as judge process is further described in reference to FIG. 6. The processing computer can evaluate the historical data from the historical database to aid in improving the large language model user support system 304. The processing computer can output analysis results from the large language model as judge process. The processing computer can store the analysis results in a development database.

At step 336, the processing computer can implement any improvements to the system as determined by the large language model as judge process. In some embodiments, the improvements can be implemented by a human expert that evaluates the analysis results. An example improvement can be that the LLM as judge identifies that the system did not connect the user to human agent as it promised, and the LLM judge can raise an alert to the developers, and the developers will fix this issue in the next iteration.

### II. Response Generation With Retrieval Augmented Generation

A retrieval augmented generation (RAG) system can enhance a user support chatbot using previously created support knowledge base digital documents. The process begins when a user (e.g., a transporter, end user, service provider, etc.) presents an issue to the chatbot. Given that the issue might be spread across several messages and follow-up questions, the processing computer first condenses the entire conversation into a summary to pinpoint a core issue that the user is experiencing. In some embodiments, the processing computer can use this summary to search historical data for a top N similar issues previously resolved with information from knowledge base digital documents. In other embodiments, the processing computer can identify a most relevant digital document based on the summary. Each potential identified issue can correspond to a specific digital document or documents in an digital document database. The processing computer can integrate an obtained digital document or documents into a prompt template. This enriched prompt template can allow the processing computer to generate a tailored response, leveraging the context of the conversation, the distilled issue summary, and the relevant knowledge base digital document(s). Doing so provides for the technical advantage of ensuring that users receive precise and informed support based on real and true information from the digital documents.

FIG. 4 shows a hybrid flow diagram illustrating response generation according to embodiments. FIG. 4 illustrates a retrieval augmented generation process. The method illustrated in FIG. 4 can be performed during steps 310-316 of FIG. 3. The method illustrated in FIG. 4 can be performed by the processing computer.

At step 402, the processing computer can receive a user query. The processing computer can receive the user query from a user device or from another computer in communication with the user device. The user query can include a chat history between a user and a chatbot.

As an illustrative example, the user query can include a chat history that includes the following text: “[Transporter]: waiting too long. [Chatbot]: are you waiting at the store? [Transporter]: yes.”

At step 404, after receiving the user query, the processing computer can generate a summary of the user query. The processing computer can generate the summary using a first large language model. The summary can include a text description that is shorter than a source text (e.g., the user query) and summarizes an issue that the user is experiencing. The processing computer can obtain the summary 406 as an output from the first large language model.

For example, the processing computer can generate a summarization prompt that prompts the first large language model to generate the summary based on the user query. The summarization prompt can include the user query. The processing computer can generate the summarization prompt using a summarization prompt template. The processing computer can input the summarization prompt into the first large language model.

As an illustrative example, the processing computer can generate the summarization prompt that includes the following text “generate a summary that identifies an issue in the following text conversation: ‘[Transporter]: waiting too long. [Chatbot]: are you waiting at the store? [Transporter]: yes.’” The summary 406 can include the following text: “the transporter is waiting too long at the store.”

At step 408, the processing computer can retrieve a user issue from an issue database 410 based on the summary 406. The processing computer can query the issue database 410 for issues related to the summary 406. For example, the processing computer can generate an issue request message comprising the summary 406. In some embodiments, the issue request message can also include a similarity threshold value that indicates an allowable similarity between the summary 406 and an issue for which the issue database 410 is to include the issue in a response. In some embodiments, the issue request message can include count value that indicates a requested number of most similar issues (e.g., 5 most similar issues) for which the issue database 410 is to include in a response. The processing computer can provide the issue request message to the issue database 410.

The issue database 410 can search through a plurality of stored issues. The issue database 410 can identify one or more stored issues that match the summary 406. The issue database 410 can compare the words in the summary 406 to the words in the stored issues to identify a match. The issue database 410 can identify matches and/or similarities in any suitable manner, such as string matching, edit distance (e.g., Levenshtein distance), cosine similarity, etc. The issue database 410 can generate an issue response message comprising one or more identified issues. The issue database 410 can provide the issue response message to the processing computer. As such, the processing computer can retrieve issues that are similar to the summary 406.

In some embodiments, if the processing computer receives more than one issue from the issue database 410, then the processing computer can select a most relevant issue to be a user issue 412 for the user or select the top N (e.g., 1-3) issues that are relevant to the user reported issue (and generate an answer referencing the solutions from the N solutions documents). In some embodiments, the processing computer can select the most relevant issue using one of the aforementioned match or similarity identification methods.

For example, in some embodiments, the processing computer can generate an issue request message comprising the summary 406 and can provide the issue request message to the issue database 410. The issue database 410 can obtain a plurality of issues that are similar to the summary 406. The issue database 410 can generate an issue response message comprising the plurality of issues and can provide the issue response message to the processing computer. The processing computer can receive the issue response message. The processing computer can select an issue of the plurality of issues to be the user issue 412.

As an illustrative example, the processing computer can obtain the user issue 412 from the issue database 410. The user issue 412 can be “long wait at the store.”

At step 414, after determining the user issue 412, the processing computer can determine a digital document 418 based on the user issue 412. The processing computer can identify the digital document 418 that is associated with the user issue 412. For example, the processing computer can communicate with a mapping database to determine an digital document identifier that is stored in association with the user issue 412. The processing computer can utilize the digital document identifier to obtain the digital document 418 from a digital document database 416.

For example, the processing computer can generate a digital document identifier request message comprising the user issue 412. The processing computer can provide the digital document identifier request message to the mapping database. The mapping database can obtain the digital document identifier that is stored in association with the user issue 412. The mapping database can generate a digital document identifier response message comprising the digital document identifier. The mapping database can provide the digital document identifier response message to the processing computer.

The processing computer can generate a digital document request message comprising the digital document identifier. The processing computer can provide the digital document request message to the digital document database 416. The digital document database can 416 identify the digital document 418 using the digital document identifier. The digital document database 416 can generate a digital document response message comprising the digital document 418. The digital document database 416 can provide the digital document response message to the processing computer. Although the retrieval of one digital document is described, it is possible that a set of digital documents could be provided to the processing computer.

As an illustrative example, the digital document 418 can include a title of “if you waited at the store for too long.” The digital document 418 can describe a solution to the user issue 412.

At step 420, after obtaining the digital document 418, the processing computer can perform a prompt generation process using a prompt template 422 to generate a prompt 424. The prompt template 422 can include a template that indicates how the processing computer is to form the prompt 424. The prompt template 422 can indicate how to include the digital document 418 into the prompt 424.

As an illustrative example, the prompt template 422 can indicate to include the whole digital document 418 in the prompt 424 along with a statement of “describe this digital document in 50 words to a user.”

In some embodiments, the processing computer can select the prompt template 422 from a plurality of prompt templates stored in a prompt template database. The processing computer can select the prompt template 422 based on the user issue(s) 412. In some cases, different user issues can be associated with different prompt templates. In other embodiments, the processing computer can select the prompt template 422 based on a digital document length, whether or not the digital document 418 includes images, digital document contents, and/or other information related to the digital document 418.

In some embodiments, the prompt template 422 can indicate to utilize one or more digital document segments of the digital document 418 rather than utilizing the whole digital document 418 as input.

At step 426, after generating the prompt 424, the processing computer can generate a response 428 using a second large language model. The processing computer can input the prompt 424 into the second large language model to generate the response 428. The second large language model can process the prompt 424 to determine the response 428.

As an illustrative example, the response 428 can include the following text “if you are waiting too long, you may ask the merchant directly for an estimated preparation time. It is also recommended to message the end user to let them know of potential delays. You can also withdraw yourself from the order if you are unable to complete the order.”

In some embodiments, the processing computer can modify the response 428. For example, the processing computer can modify the response 428 to include a link to the digital document 418 as hosted on a webpage for the user of the user device to view for further information.

In some embodiments, the second large language model can be the same large language model as the first large language model. In other embodiments, the first large language model and the second large language model can include different large language models.

After generating the response 428, the processing computer can evaluate the response 428, as described in reference to FIG. 5.

### III. Large Language Model Output Guardrail

A function of the guardrail system can be to detect hallucinations, where the large language model's generated responses are unrelated or only partially related to the digital document(s). Initially, an experiment was performed to test a more sophisticated model as a guardrail, but it was found to be prohibitively computationally expensive due to increased response times and heavy usage of model tokens to be effective in a real-time response system. Rather, embodiments provide for a technically advantageous two-tier approach: a computationally cost-effective shallow check followed by a large language model-based evaluator.

The shallow check, which is performed by a NLP embedding guardrail 502, employs a sliding window technique to measure similarity between the large language model's responses and the digital documents or digital document segments utilized for response generation. If a response closely matches the digital document segments or common phrases, it's less likely to be a hallucination. The shallow check process can generate a flag that indicates whether or not the response includes content that is similar to the digital document.

If the NLP embedding guardrail 502 flags the response as being inaccurate, a prompt is constructed that includes the initial response, the relevant digital document(s), and the user query. The prompt is then passed to an evaluation model, which is a large language model as guardrail 504, that assesses whether or not the response is grounded in the provided information and offers a rationale for further debugging if necessary.

One drawback of this large language model-based guardrail system can be the latency it introduces, as the end-to-end process includes generating the original response, applying the large language model guardrail, and possibly retrying with another guardrail check. Given the relatively small number of problematic responses, strategically defaulting to human agents can be an effective way to balance user experience with the cost of human resources (e.g., time). To reduce latency, embodiments can use summarization of the chat transcript to reduce the length of the content as well as include instructions in the prompts to limit the length of the LLM output. During testing, through this guardrail system, embodiments have successfully reduced overall hallucinations by 90% and cut down potentially severe compliance issues by 99%.

FIG. 5 shows a hybrid diagram illustrating a response output guardrail system and method according to embodiments. The response guardrail system can be an online monitoring tool that evaluates each output response from the large language model (e.g., the second large language model as described in reference to FIG. 4) to ensure accuracy and compliance. The large language model guardrail system checks the grounding of retrieval augmented generation based information to prevent hallucinations, maintain response coherence with previous conversations, and filter out responses that violate policies, laws, rules, etc.

FIG. 5 includes a natural language processing (NLP) embedding guardrail 502, a large language model as guardrail 504, and a context 506. The processing computer can obtain the response 428 that was generated by the second large language model as described at step 426 of FIG. 4.

At step 510, the processing computer can generate a response embedding using the response 428. An embedding can be a representation of data such as text, images, and audio as points in a continuous vector space where the locations of those points in space are semantically meaningful to algorithms. For example, words can be represented as vectors where similar words (e.g., “happy” and “joyful”) are closer together in a vector space. As another example, in natural language processing, an embedding might represent “cat” as [0.2, −0.4, 0.7], “dog” as [0.3, −0.5, 0.6], and “car” as [0.8, 0.1, −0.2], which places the words for “cat” and “dog” close together in a vector space, which reflects their similarity to one another, while the word for “car” is farther away in the vector space. Word embeddings can be generated for text using a process such as Word2Vec or a transformer such as bidirectional encoder representations from transformers (BERT).

The processing computer can generate the response embedding using a transformer or other suitable process. The processing computer can generate the response embedding based on the whole of the response. As such, the response embedding can represent the sentence that is the response.

After generating the response embedding, the processing computer can obtain the digital document from the digital document database 416. The processing computer can identify one or more digital document segment embeddings in a digital document segment embedding database 508 that is associated with the digital document. The digital document embeddings can be pre-generated and stored in the digital document segment embedding database 508.

For example, a digital document can be split into four segments. Each of the four segments can be utilized to determine a digital document segment embedding. The processing computer, or other computer, can generate the digital document segment embeddings for each segment of the digital document.

In some embodiments, a digital document segment embedding might not yet exist for a particular digital document. The processing computer can generate a digital document segment embedding based on the digital document.

In other embodiments, a digital document segment embedding might already exist for a particular digital document and can be stored in a digital document segment embedding database in association with a digital document identifier.

At step 512, the processing computer can compare the digital document embedding and the response embedding. The processing computer can determine a similarity score between the two embeddings. For example, the processing computer can determine a distance between the two embedding vectors.

For example, the processing computer can determine a similarity score by comparing the digital document segment embedding with the response embedding. The similarity score can indicate how much the digital document segment matches the response. The similarity score can indicate how closely the content of the text sources for the embeddings relate to one another.

At step 514, the processing computer can compare the similarity score to a similarity score threshold to determine whether or not the two texts are similar. If the two texts are similar, then the processing computer can proceed to step 528. If the two texts are not similar, then the processing computer can proceed to step 520.

At step 520, if the similarity score is below a similarity score threshold, the processing computer can obtain a guardrail prompt template based on the context 502. The processing computer can generate a guardrail prompt using on the guardrail prompt template.

At step 522, the processing computer can provide the guardrail prompt to the large language model. The processing computer can utilize the large language model to generate a new response using the guardrail prompt. For example, the processing computer can regenerate the response based on the guardrail prompt using the second large language model.

At step 524, the processing computer can evaluate the new response from the large language model for groundness, coherence, compliance, and/or any other qualities. If the new response does not satisfy the qualities, then the processing computer can proceed to step 526. If the new response satisfies the qualities, then the processing computer can proceed to step 528.

At step 526, the processing computer can trigger a fallback response. For example, rather than utilizing the response or the new response, which were both identified as being unusable, the processing computer can trigger a fallback response such as indicating the chatbot to ask the user for more information, providing a message to the user device via the chatbot or other means by a human agent, providing a message to the user device that includes a link to a support website that provides access to digital documents for the user to search through, etc.

At step 528, after identifying that the response or the new response is usable, the processing computer can send the response or the new response to the user device. The response or the new response can be provided by to the user device via the chatbot, a notification in a fulfilment application, a short messaging service (SMS) message, etc.

### IV. Large Language Model Judge

The quality of the responses generated by the large language model can be evaluated from multiple perspectives, such as user feedback, human engagement rate, delivery speed, etc. However, none of the above provides actionable feedback to further improve the quality of the chatbot system. After reviewing thousands of chat transcripts between the large language model and users during an experiment, several aspects were identified and an iteration pipeline was defined to monitor the large language model quality. The quality of the large language model can be divided into the following aspects: 1) retrieval correctness, 2) content correctness and groundness, 3) grammar and language correctness, 4) coherence to the context, and 5) helpfulness to the user's request.

For each aspect, the system includes monitors that are built by either prompting a more sophisticated large language model or creating rule based (e.g., regular expressions (regex), etc.) metrics. The overall quality of each aspect is handled by prompting a large language model with open-ended questions. The answers of the open-ended questions are processed and summarized into common issues. High frequency issues can be built into prompts or rules for further monitoring.

Beyond the automated large language model quality evaluation system, the system can also include a human evaluation team to review a randomly sampled subset of the transcripts. A continuous calibration between human review and automated review system can ensure the coverage and effectiveness of the automated review system.

FIG. 6 shows a hybrid diagram illustrating a large language model judge system and quality improvement framework according to embodiments. FIG. 6 includes a large language model as judge phase 600 and a quality interaction phase 601. In some embodiments, the modules and steps described in reference to FIG. 6 can be respectively included in and performed by a processing computer.

During the large language model as judge phase 600, a judge module 602 can process a review of a previous user query and response. The judge module 602 can include a large language model as a judge that can be utilized to review previous results. The judge module 602 can obtain data that can aid in evaluating a previous user query and response. For example, the judge module 602 can obtain an open ended review document 604, historical data 606, a historical transcript 608, a judge template 610, and in some cases, a structured review document 618. The judge module 602 will first be described in reference to utilizing the open ended review document 604 rather than the structured review document 618.

The judge module 602 can obtain the open ended review document 604. The open ended review document 604 can include an open ended question that is to be provided to the judge module 602. The open ended review document 604 can aid in prompting the judge module 602 to evaluate a previous user query and response based on certain metrics.

For example, the open ended review document 604 can be a question of “why is the user not happy,” “why did the user first message the chatbot,” “was the response to the user's query actionable,” or other question relating to the user query, the response, the fulfilment system, the chatbot and/or a large language model.

The judge module 602 can obtain the historical data 606. The historical data 606 can include data related to the user query, the response, the user, the user device, and/or the user's current task. The historical data 606 can include previous user queries and responses, previous user fulfilment data, etc.

The judge module 602 can obtain the historical transcript 608. The historical transcript 608 can include a full chat history between a user and a chatbot. While the user query may include a portion of a chat history between the user and the chatbot that is relevant to the user query, the historical transcript 608 can include all messages sent between the user and the chatbot and may relate to a plurality of user queries.

The judge module 602 can obtain the judge template 610 from a template database. The judge template 610 can indicate instructions for how to include the historical data 606, the historical transcript 608, and the open ended review document 604 into a prompt for the judge module 602 to process.

The judge module 602 can generate a prompt using the judge template 610, the open ended review document 604, the historical data 606, and the historical transcript 608. The judge module 602 can generate the prompt based on the prompt template of the judge template 610.

As an illustrative example, the prompt can include the following text: “why is the user not happy with the previous response to the previous user query. The previous user query was [text from the previous user query]. The previous response was [text from the previous response]. Previously the user had the following conversation with the chatbot: [text from the historical transcript].”

The judge module 602 can input the prompt into the large language model as a judge to process the prompt. The judge module 602, in conjunction with the large language model as a judge, can generate an output based on the prompt. The output can include an answer to the question posed in the open ended review document 604 as described by the judge template 610 in view of the historical data 606 and the historical transcript 608.

As an illustrative example, the output can include the following text: “the user was not happy with the previous response to the previous user query because the user speaks Spanish, but the responses are in English.”

If the current review is an open ended review using the open ended review document 604, then the judge module 602 can store the output into the open ended results database 612. If the current review is a structured review using the structured review document 618, then the judge module 602 can store the output into the structured results database 620.

During the quality iteration phase 601, an analysis and summarization module 614 can analyze and summarize an output obtained from the open ended results database 612. The results and analysis can include qualitative and quantitative analysis of the outputs generated by the judge module 602. The analysis and summarization module 614 can generate analysis results based on the output from the judge module 602.

For example, the analysis and summarization module 614 can generate analysis results that includes a summary of the judge model's 602 output, a summary of the user query and response, a summary of the case using a large language model, an analysis including a semantic analysis of the user query, the response, and/or the historical transcript, an analysis including a number of similar user queries in a historical data database, an analysis including numerical values related to the case such as a time taken to generate the response, a time of receiving the user query, a time of providing the response, a similarity score determined by a guardrail LLM, etc., and/or any other summary or analysis of data related to the user query, response, and/or processing thereof.

The analysis and summarization module 614, or a computer comprising the analysis and summarization module 614, can provide the analysis results to an expert review module 616 and a system improvements module 624, which will be described in further detail below.

The expert review module 616 can prompt an expert to review the analysis results generated using the open ended review document 604. The expert can generate a structured review document based on the analysis results. For example, for the open ended review question of “why is the user not happy,” the judge module 602 can generate an output of “the user speaks Spanish, but the responses are in English.” The expert can generate a new structured review document 618 that can review the languages used by the large language model and the user. The new structured review document can be a language check structured review document. The new structured review document can be stored along with a plurality of other structured review documents.

On a subsequent review, the judge module 602 can perform a structured review using the structured review document 618 (e.g., the language check structured review document). The judge module 602 can process a prompt created in accordance with the judge template 610 and can determine an output. The output can be stored in the structured results database 620.

As an illustrative example, the structured review document 618 can include a question of “is the response in the same language as the user query.” The judge module 602 can generate a prompt that includes the following text “is the response of [text from the response] in the same language as the user query of [text from the user query].” The output generated by the judge module 602 can include the following text “yes, the user query and the response are both in Spanish.”

The judge module 602 can store the output into the structured results database 620. The structured results from the structured results database 620 can be displayed on a reporting dashboard 622. A user can utilize the reporting dashboard 622 to select and/or input improvements to one or more of the large language models in the user support system (e.g., the large language model user support system 304 as illustrated in FIG. 3).

The reporting dashboard 622, upon receiving input to implement a particular improvement, can provide data relating to the improvement (e.g., modified templates, modified usage of historical data in prompts, new digital documents, new issues, modified digital documents, modified issues, etc.) to a system improvements module 624. The system improvements module 624 can implement system improvements based on the reporting dashboard 622 and/or the analysis and summarization module 614.

The system improvements module 624 can implement the indicated improvement. For example, the system improvements module 624 can route data to database for storage. The system improvements module 624 can send a modified template to a templates database. The system improvements module 624 can store a new digital document in a digital document database. The system improvements module 624 can store a new issue in an issue database.

After implementing the improvement(s), the system improvements module 624 can notify an improvements tracking module 626 of the improvement. The improvement's impact can be tracked over time. In some embodiments, improvements can be tracked as new structured review document. An improvement can be, for example, a new review question that is seen to improve large language model response accuracy compared to a related previous review question. As another example: if the response contains anything blaming the other party in the process (transporter, restaurant, etc.), then this can evaluated/corrected.

### V. Fulfilment System

FIG. 7 shows a system 700 according to embodiments of the disclosure. The system 700 comprises one or more end user devices 702, a central server computer 704, a fulfillment request database 706, a logistics platform 708, one or more service provider computers 710, one or more transporter user devices 714, one or more transporter vehicles 715, and a navigation network 716.

The central server computer 704 can be in operative communication with the one or more end user devices 702, the fulfillment request database 706, the logistics platform 708, the one or more service provider computers 710, the transporter user device 714, the transporter vehicles 715, and in some embodiments, the navigation network 716. Further, the one or more transporter user devices 714 can be in operative communication with the navigation network 716. In some embodiments, the transporter vehicles 715 can be in operative communication with the navigation network 716. The processing computer 718 can be in operative communication with the end user devices 702 and the transporter user devices 714.

Transporters can pick up orders from merchants (e.g., service providers) and deliver resources to end users that operate end user devices 702. Transporters often need help from a computer, such as a processing computer as described herein, to help them resolve the issues they meet in the delivery process, especially for new transporters. The processing computer can be the central server computer 704 or an additional computer. FIG. 7 and the methods described herein describe the process of improving the existing transporter support system using large language models and a RAG system (retrieval augmented generation), and how the system is managed with a large language model judge, a large language model guardrail, and quality evaluation.

Messages between at least the devices in FIG. 7 can be transmitted using a secure communications protocols such as the secure communications protocols described in reference to FIG. 1, above.

The one or more end user devices 702 includes devices operated by end users. The one or more end user devices 702 can generate and provide fulfillment request messages to the central server computer 704. The fulfillment request message can indicate that the request (e.g., a request for a service) can be fulfilled by one or more service provider computers 710. For example, the fulfillment request message can be generated based on a cart selected at checkout during a transaction using a central server computer application installed on the end user device 702. The fulfillment request message can include one or more items from the selected cart.

For example, the fulfillment request message can be a request for a food item (e.g., a hamburger) to be prepared by a specific service provider computer 710 and delivered to an end user location by a transporter that operates a transporter user device and, in some embodiments, a transporter vehicle.

The end user device 702 can provide a fulfillment request message to the central server computer 704 that indicates that the end user device 702 is requesting that a transporter of a transporter use device 714 pickup an item from a pickup location and deliver the item to a drop-off location. The pickup location can be a location in which items are stored. In the context of an outbound delivery from an end user at an end user location, examples of the pickup location may be a house or an apartment, a mailbox, a service provider location (e.g., a retail store, a grocery store, a dry cleaning store), a pickup hub, etc. Items can first be obtained from a pickup location and then be transported to the drop-off location. Examples of the drop-off location can be similar to the pickup location, such as a house or apartment, a mailbox, a retail store, a grocery store, a dry cleaning store, a pickup hub, etc. In one example, the pickup location can be a pizza parlor from which the end user orders a pizza. The drop-off location can be an apartment in which the end user resides.

The central server computer 704 includes a server computer that can facilitate in the fulfillment of fulfillment requests received from the one or more end user devices 702. For example, the central server computer 704 can identify one or more transporters operating one or more transporter user devices 714 that are capable of satisfying the fulfillment request. The central server computer 704 can identify the transporter user device 714 that can satisfy the fulfillment request based on any suitable criteria (e.g., transporter location, service provider location, end user destination, end user location, transporter mode of transportation, etc.). The logistics platform 708 may provide real time data regarding locations of the various service providers, transporters, and end users to the central server computer 704.

The central server computer 704 can receive data relating to a delivery order of items from the service provider computer 710 to the end user of the end user device 702 at a drop-off location. The central server computer 704 can determine a route for delivery of the delivery order. The central server computer 704 can present the routes to a plurality of transporter user devices 714 and/or transporters. The central server computer 704 can receive acceptances from a transporter user device that will deliver the items from a pickup location to the drop-off location.

The central server computer 704 can receive data from user devices. For example, the central server computer 704 can receive fulfilment data, image data, item data, etc. from the transporter user device 714. The central server computer 704 can also receive data from the end user device 702. The central server computer 704 can store the data into a database.

The central server computer 704 can maintain and update item listings that can be accessible in a delivery application managed by the central server computer 704. The delivery application can be installed on end user devices and can allow end users to select items from the item listings to have delivered to the end user from a service provider location by a transporter. In some embodiments, the central server computer 704 can update item listings based on item information data entries in an item information database.

The logistics platform 708 can include a location determination system, which can determine the locations of various user devices such as the transporter user devices 714 and the end user devices 702. The logistics platform 708 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 708 can be part of the central server computer 704 or can be a system that is separate from the central server computer 704.

The fulfillment request database 706 can store data related to previous (e.g., historical) fulfillment requests. For example, after a fulfillment request is fulfilled, the central server computer 704 can store fulfillment request data into the fulfillment request database 706. For example, the central server computer 704 can store any spatial-temporal fulfillment data (e.g., transporter user device location over time, transporter user device motion data over time, length of time taken to fulfil the fulfillment request, a fulfillment time, a fulfillment location, etc.), fulfillment service data (e.g., fulfilled services, an amount, a service provider computer identifier, an end user device identifier, a transporter user device identifier, etc.), and any other data relating to the fulfillment request and/or the fulfillment of the fulfillment request.

The one or more service provider computers 710 include computers operated by service providers. For example, a service provider computer can be a food provider computer that is operated by a food provider. The one or more service provider computers 710 can offer to provide services to the end users of the one or more end user devices 702. The service provider computer 710 can receive requests to prepare one or more items for delivery from the central server computer 704. The service provider computer 710 can initiate the preparation of the one or more items that are to be delivered to the end user of the end user device 702 by a transporter of a transporter user device 714.

The one or more transporter user devices 714 can be devices operated by transporters. The one or more transporter user devices 714 can be smartphones, wearable devices, personal assistant devices, etc. A transporter using a transporter user device 714 can provide a request to fulfill an end user's fulfillment request. For example, the transporter user device 714 can generate and transmit a request to fulfill a particular end user's fulfillment request to the central server computer 704. The central server computer 704 can notify the transporter user device 714 of the fulfillment request. The transporter user device 714 can respond to the central server computer 704 with a request to perform the delivery to the end user as indicated by the fulfillment request. In some embodiments, the one or more transporter user devices 714 are communication devices in autonomous vehicles.

In some embodiments, a transporter can operate a transporter user device 714 and a transporter vehicle 715. For example, a transporter can be a delivery person, the transporter user device 714 can be the delivery person's mobile phone, and the transporter vehicle 715 can be a car that is operated by the delivery person. The transporter vehicles 715 can include cars, bikes, mopeds, skateboards, public transit vehicles, etc. In some embodiments, a transporter may not utilize a transporter vehicle 715 (e.g., the transporter can deliver the items of the fulfillment request by foot).

In some embodiments, the central server computer 704 can identify the transporter vehicle 715 that can satisfy the fulfillment request based on any suitable criteria (e.g., transporter vehicle location, transporter vehicle type, transporter vehicle battery charge level, transporter vehicle weight limit, service provider location, end user destination, end user location, etc.). The transporter vehicles 715 can include autonomous vehicles that can operate without receiving input from a transporter.

The navigation network 716 can provide navigational directions to the one or more transporter user devices 714. For example, the transporter user device 714 can obtain a location from the central server computer 704. The location can be a service provider parking location, a service provider location, an end user parking location, an end user location, etc. The navigation network 716 can provide navigational data to the location. For example, the navigation network 716 can be a global positioning system that provides location data to the transporter user device 714. In some embodiments, the transporter vehicle 715, which can be an autonomous vehicle, can communicate with the navigation network 716 to direct the transporter vehicle 715 to the destination.

### VI. Advantages

Embodiments of the disclosure provide for a number of technical advantages. For example, embodiments provide for large language models that can have a conversation with a user to understand an issue and describe a resolution of the issue. Large language models are known to hallucinate (e.g., provide wrong answers) on a low frequency. However, the system according to embodiments overcomes such a limitation due to the guardrail system.

Embodiments face and provide solutions to several technical challenges related to quality, including an insufficient knowledge base, inaccurate retrieval, model hallucination, and suboptimal prompts.

Embodiments provide for knowledge base technical improvements. The knowledge base (e.g., a digital document database) serves as a foundational truth for the large language model responses. An incomplete or inaccurately phrased knowledge base can lead to erroneous responses from the large language model. Based on a quality evaluation with the large language model judge, the system can conduct thorough reviews and updates of the digital document database to eliminate misleading terminology as identified by the system. Additionally, embodiments include systems that can dynamically prompt the creation of new digital documents based on evaluations of user queries and responses.

Embodiments also provide for technical improvements to retrieval of digital documents. Effective retrieval involves query contextualization. Embodiments can simplify queries to a single, concise prompt, using a large language model, while providing a comprehensive conversation history to contextualize the information. By summarizing a user query into a summary, the system can easily identify user issues and digital documents that relate to the user query.

Embodiments provide for prompt improvement. Refining prompts is an essential aspect of guiding the large language model accurately. Depending on the large language model base model, prompt refining can range from easy to difficult. The approach according to embodiments can follow the following principles. Breaking down complex prompts into smaller, manageable parts and employing parallel processing where feasible. Avoiding negative language in prompts, as models typically struggle with these. Instead, desired actions are clearly outlined and provide illustrative examples. Implementing Chain-of-Thought prompting to encourage the model to process and display its reasoning, aiding in the identification and correction of logic errors and hallucinations.

Furthermore, embodiments can decrease latency of the response system by carefully designing the prompts. For example, a prompt can indicate to a large language model utilize a set number of words, which both decreases the latency of the response since it can be generated faster, and also allows for a more readable and actionable response that is provided to the user device.

To reduce latency, embodiments implement several strategies aimed at reducing the overall time taken by the large language model so that the user can receive a response in a timely manner. One method of reducing latency involves the summarization of the chat transcript. By condensing the transcript, the computer can significantly reduce the amount of content that the large language model needs to analyze and consider with each new prompt. This approach not only streamlines the context provided to the model, but also helps to ensure that only the most relevant and salient points from prior exchanges are included. Consequently, the model can process subsequent prompts more quickly, as it is not encumbered by a lengthy and potentially redundant conversation history.

In addition to transcript summarization, embodiments can utilize explicit embedded instructions within the prompt to restrict the length of the large language model's output. By guiding the large language model to produce concise and focused responses, embodiments decrease the computational resources required for text generation since fewer words are needed to be generated as output. This, in turn, directly impacts latency by reducing the time taken from the receipt of the prompt to the delivery of the response. Limiting output length also contributes to maintaining clarity and relevance, which can further enhance overall system performance and user satisfaction.

Together, these measures work in tandem to reduce latency in the response system. This ensures that users receive timely, relevant, and actionable information without unnecessary delay.

Embodiments provide for a technical advantage of regression prevention. To maintain prompt quality and model performance, embodiments can an evaluation tool akin to unit testing in software development. This tool allows the system to quickly refine prompts and evaluate model responses. With a suite of predefined tests, any changes in prompts trigger these tests, blocking any failing prompts. Newly identified issues are systematically added to the test suites, ensuring continuous improvement and prevention of regression in model performance.

Furthermore, each day, the system according to embodiments can assist thousands of users in resolving their queries autonomously, reducing the need for human intervention. This not only accelerates delivery operations, but also significantly cuts time costs associated with human support for basic inquiries. This also allows human support representatives to focus their energy on solving more complex problems for users. The quality monitoring and iterative improvement pipeline have transformed an initial prototype into a robust chatbot solution, serving as a cornerstone for further advancements in our automation capabilities.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, a user query;
generating, by the computer, a summary of the user query using a first large language model;
determining, by the computer, a user issue from a first database based on the summary;
determining, by the computer, a digital document from a second database based on the user issue;
generating, by the computer, a prompt based on the digital document and a prompt template; and
generating, by the computer, a response based on the prompt using a second large language model.

2. The method of claim 1, wherein the user query includes a chat history between a user and a chatbot.

3. The method of claim 1, wherein after generating the response, the method further comprises:
evaluating, by the computer, quality of the response.

4. The method of claim 3, wherein evaluating the quality of the response comprises:
generating, by the computer, a digital document segment embedding based on the digital document;
generating, by the computer, a response embedding based on the response; and
determining, by the computer, a similarity score by comparing the digital document segment embedding with the response embedding.

5. The method of claim 4, wherein evaluating the quality of the response further comprises:
if the similarity score is below a similarity score threshold, obtaining, by the computer, a guardrail prompt template;
generating, by the computer, a guardrail prompt using the guardrail prompt template; and
regenerating, by the computer, the response based on the guardrail prompt using the second large language model.

6. The method of claim 1, wherein the user query is received from a user device and wherein the method further comprises:
providing, by the computer, the response to the user device.

7. The method of claim 1, wherein generating the summary comprises:
generating, by the computer, a summarization prompt using a summarization prompt template and the user query;
inputting, by the computer, the summarization prompt into the first large language model; and
obtaining, by the computer, the summary as output from the first large language model.

8. The method of claim 1, wherein determining the user issue comprises:
generating, by the computer, an issue request message comprising the summary;
providing, by the computer, the issue request message to a third database, wherein the third database obtains a plurality of issues that are similar to the summary, generates an issue response message comprising the plurality of issues, and provides the issue response message to the computer;
receiving, by the computer, the issue response message; and
selecting, by the computer, an issue of the plurality of issues to be the user issue.

9. The method of claim 1, wherein determining the digital document comprises:
generating, by the computer, a digital document identifier request message comprising the user issue;
providing, by the computer, the digital document identifier request message to a third database, wherein the third database obtains a digital document identifier that is stored in association with the user issue, generates a digital document identifier response message comprising the digital document identifier, and provides the digital document identifier response message to the computer;
receiving, by the computer, the digital document identifier response message;
generating, by the computer, a digital document request message comprising the digital document identifier providing, by the computer, the digital document request message to the second database, wherein the second database identifies the digital document using the digital document identifier, generates a digital document response message comprising the digital document, and provides the digital document response message to the computer; and
receiving, by the computer, the digital document response message comprising the digital document.

10. The method of claim 1, further comprising:
selecting, by the computer, the prompt template from a plurality of prompt templates stored in a prompt template database.

11. The method of claim 1, wherein the prompt is a first prompt, wherein the method further comprises:
obtaining, by the computer, an open ended review document, a judge template, a historical transcript, and historical data comprising the response and the user query;
generating, by the computer, a second prompt using the open ended review document, the judge template, the historical transcript, and the historical data;
generating, by the computer, an output using a third large language model and the second prompt; and
storing, by the computer, the output into an open ended results database, wherein the output is analyzed and summarized by an analysis and summarization module to improve performance of the computer, the first large language model, and/or the second large language model.

12. A computer comprising:
a processor; and
a non-transitory computer readable medium comprising code, executable by the processor for performing a method comprising:
receiving a user query;
generating a summary of the user query using a first large language model;
determining a user issue from a first database based on the summary;
determining a digital document from a second database based on the user issue;
generating a prompt based on the digital document and a prompt template; and
generating a response based on the prompt using a second large language model.

13. The computer of claim 12, wherein the method further comprises:
obtaining a digital document segment embedding that is associated with the digital document, from a third database;
generating a response embedding based on the response;
determining a similarity score by comparing the digital document segment embedding with the response embedding; and
comparing the similarity score to a similarity score threshold to determine quality of the response.

14. The computer of claim 13, wherein if the similarity score is less than the similarity score threshold, the method further comprises:
obtaining a guardrail prompt template;
generating a guardrail prompt using guardrail prompt template, the digital document, and the user issue; and
regenerating the response based on the guardrail prompt using the second large language model.

15. The computer of claim 12, wherein the prompt is a first prompt, wherein the method further comprises:
obtaining a structured review document, a judge template, a historical transcript, and historical data comprising the response and the user query;
generating a second prompt using the structured review document, the judge template, the historical transcript, and the historical data;
generating an output using a third large language model and the second prompt; and
storing the output into a structured results database, wherein the output is provided to a dashboard.

16. The computer of claim 12, wherein determining the user issue comprises:
generating an issue request message comprising the summary;
providing the issue request message to a third database, wherein the third database obtains a plurality of issues that are similar to the summary, generates an issue response message comprising the plurality of issues, and provides the issue response message to the computer;
receiving the issue response message; and
selecting an issue of the plurality of issues to be the user issue.

17. The computer of claim 12, wherein the user query includes a text question.

18. A method comprising:
displaying, by a user device, a text chat between a user and a chatbot hosted by a computer;
receiving as input, by the user device, one or more text messages from the user for the text chat;
providing, by the user device, the one or more text messages to the computer, wherein the one or more text messages and other messages from the text chat are included in a user query, wherein the computer generates a summary of the user query using a first large language model, determines a user issue from a first database based on the summary, determines a digital document from a second database based on the user issue, generates a prompt based on the digital document and a prompt template, and generates a response based on the prompt using a second large language model; and
receiving, by the user device, the response from the computer.

19. The method of claim 18, wherein the response includes a link to the digital document.

20. The method of claim 19, wherein the digital document is an article.
